(19) United States
(12) Patent Application Publication
(10) Pub. No.: US 2003/0004702 A1
(43) Pub. Date: Jan. 2, 2003

(54) Partial sentence translation memory program

(76) Inventor: Dan Higinbotham, Orem, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/897,805

(22) Filed: Jun. 29, 2001

(51) Int. Cl. G06F 17/28

(52) U.S. Cl. 704/2

(57) ABSTRACT

The present invention features a partial sentence translation memory integrated within a workbench program, that identifies, or operates to determine, previously translated partial sentences existing within text data. The partial sentence translation memory comprises an algorithm that allows a translator to identify partial sentence translations instead of entire sentence translations. The algorithm causes a computer to access a database of previously translated material contained within either the workbench program or in the partial sentence translation memory program itself. The workbench program or the partial sentence translation memory is capable of determining whether or not a given partial sentence from a source document has been previously translated. The purpose of the algorithm of the present invention is to allow a translator to see at a single glance what parts of a text segment within a source document have been previously translated. Specifically, a translator is able to identify previously translated sentence fragments existing within a source language text segment, such as phrases or other non-sentence structures.

### BACKGROUND

1. Field of the Invention

The field of this invention relates to computer translation programs. Specifically, this invention relates to a computer translation system comprising a partial sentence or phrase translation memory program capable of identifying or determining previously translated partial sentences existing within a source language text segment, wherein the partial sentences are identified from a database of previously translated material.

2. Background

The task of translating documents or material from language to language may be facilitated with several tools or aids. Traditionally, such aids or tools existed in paper form that include monolingual and bilingual dictionaries and terminology glossaries. However, with the advent of computers and the ever increasing capabilities of computer systems, the once tedious task of translating material from a source language to a target language has been greatly simplified. Translators are now capable of working within the context of a word processing or DTP environment comprising some type of translation software package, commonly referred to as a translator's workbench or workbench program. This workbench program is a single integrated software package comprising a text editor or word processor into which a number of translation-related tools are integrated for rapid and easy access. Alternatively, stand-alone translation software can be installed on a translator's computer system or workstation. Although a significant amount of autonomous effort is still required to entirely translate material from a source language (the untranslated material) into a target language (the translated material), computers have allowed translators to produce high-accuracy translations in a much shorter time frame.

Employing the use of computer systems to reduce the translation time and to aid in the translation of material is referred to in the industry as machine assisted human translation (“MAHT”) or interactive translation. Machine assisted human translation has focused on ways of using computer systems to significantly reduce the amount of autonomous time and effort required to complete a translation. MAHT and Terminology Management Tools are based on the concept of automating the re-use of previously translated sentences. These tools are designed for use by professional translators and do not automatically produce computer-generated translations. Instead they allow the translator to improve his/her productivity and consistency by re-using terms and sentences they have translated in the past.

The procedure by which MAHT systems are capable of producing high-quality and accurate translations is found in their ability to identify portions of a source language, from a source document, that are to be translated into a target language; then to extrapolate fragments of known or previously translated material of the target language, usually contained within an index or database, based upon the identified source language information to create the translated target language. The remaining material from the source language or document that was unobtainable by the computer system is then filled in autonomously to complete the translation. In prior art translation systems, the fragments extrapolated by the computer system are on a sentence by sentence basis. This means that only entire sentences may be recognized by the computer system and translated into the target language. For example, a translator wishing to translate a document from English to French, may be assisted by causing the computer system to extrapolate all previously translated sentences from the source document that are found in the index or database of previously translated material and returning their French equivalents. Those sentences not found must then be transferred autonomously.

An example of a MAHT tool is a translation memory (“TM”). A translation memory is a database that collects translations as they are performed along with the source language equivalents. After a number of translations have been performed and stored in the translation memory, it can be accessed to assist new translations where the new translation includes identical or similar source language text as has been included in the translation memory.

Although translation programs and MAHT translation systems greatly aid in the translation of source material into a target material, their ability to yield large amounts of translated material from a specific source document into a target language is limited. The limitations of these systems stem from the fact that they operate on a sentence by sentence basis. Put another way, these systems are only capable of finding similar full sentences from the source document. This is because TM systems are only capable of storing previously translated sentences.

As conventional TM systems have the limitation that they operate only at the sentence, their overall benefit to a translator is limited. Conventional TM systems rely on a close or “fuzzy” match between the sentence to be translated and those stored within the TM database. As sentences often do not match directly, especially from source document to source document, the degree of “fuzziness” between sentences returned and those desired is greatly increased. As such, the translation draft is much less accurate, thereby requiring the translator to perform a greater percentage of the translation by hand.

Other prior art translation memory systems are able to work with units of text contained within a sentence, such as a word or phrase, but only if they are manually stored with a lexicon.

In addition, although TM systems provide significant advantages, they are not ideal for stand-alone documents, multiple terminology documents, or short documents. Conventional TM systems are particularly suitable for highly technical documents, documents with specialized vocabularies, large documents, related documents, and documents containing large amounts of recurring text. As such, their ability to provide accurate, high percentage translations varies from document to document.

Therefore, what is needed is a translation memory system capable of operating on a partial sentence basis. Specifically, what is needed is a MAHT that is capable of returning those partial sentence fragments to the translator for more expansive application of the TM and improved translation accuracy.

### SUMMARY AND OBJECTS OF THE INVENTION

The present invention advances prior art translation memory systems by providing a partial sentence translation memory, integrated with a workbench program that operates, or is capable of translating text, on a partial sentence or phrase basis. The partial sentence translation memory comprises an algorithm that allows a translator to determine or find partial sentence translations instead of entire sentence translations as featured in conventional translation memory systems.

The primary purpose of the algorithm, and the crux of the present invention, is to allow a translator to see at a single glance what parts of a text segment existing within a source document have been previously translated. Specifically, a translator is able to find translated sentence fragments, such as phrases or other non-sentence structures. As such, a partial sentence may be considered as simply a sequence of words contained within a segment of text. In a preferred embodiment, this process or procedure is carried out by the partial sentence translation memory by determining the longest phrase ending with the last word. However, the partial sentence translation memory could be designed to start with the beginning word in the text segment as the first step.

The algorithm interfaces with a workbench program, as previously described, and causes a computer to access one or more databases, such as an inverted word index, that contains previously translated material. The workbench program comprises computer readable software that functions to determine whether or not a given partial sentence from a source document has been previously translated and allows the translator to see at a single glance as much. Moreover, punctuation and capitalization are ignored in order to obtain more accurate returns.

The algorithm of the present invention provides significant advantages over prior art translation memory programs. Unlike the present invention partial sentence translation memory, prior art translation memory programs are unduly limited in their capabilities to offer the translator efficient, accurate, and high percentage translation assistance.

Therefore, it is an object of the preferred embodiments of the present invention to provide a partial sentence, or phrase, partial sentence translation memory.

It is another object of the preferred embodiments of the present invention to provide a partial sentence translation memory and system that allows a translator to see at a single glance the parts of a text segment, namely partial sentences such as phrases and the like, that have been previously translated.

It is still another object of the preferred embodiments of the present invention to provide a database of previously translated material, such as an inverted word index, that interfaces and interacts with the partial sentence translation memory, wherein the database is capable of storing and presenting partial sentence translations, or phrases, as directed by the partial sentence translation memory.

It is a further object of the preferred embodiments of the present invention to provide a partial sentence translation memory that provides the translator the ability, if desired, to store and receive updates of partial sentence translations.

It is still further an object of the preferred embodiments of the present invention to provide an efficient and accurate method of translation capable of increasing a translator's ability to translate source documents based on partial sentences.

To achieve the foregoing objects, and in accordance with the invention as embodied and broadly described herein, the present invention features a partial sentence translation memory for assisting a translator in translating text data based on partial sentences. The present invention further features a method for assisting a translator in translating source documents based on partial sentences and computer readable code that directs a computer to determine whether text data has been previously translated based on partial sentences. Each of these is discussed in greater detail below.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a computer system environment, or workstation, indicating various ways a source document may be introduced into the system, and specifically the writeable text data application program;

FIG. 2 illustrates generally the translation system, and particularly the partial sentence translation system, according to the present invention;

FIG. 3 illustrates the interaction of the partial sentence translation memory, as well as the workbench program, with the several translation memory databases possible in the present invention and with each other;

FIG. 4 illustrates a general flow chart representative of the sequential steps of the partial sentence translation memory algorithm of the present invention;

FIG. 5 illustrates a technical flow chart representative of the detailed sequential steps performed by the partial sentence translation memory algorithm to determine partial sentences, or phrases, that have been previously translated;

FIG. 6 illustrates the graphical user interface and the several databases that may be retrieved and viewed therein;

FIG. 7 is a flowchart showing the life cycle of a partial sentence as it progresses from existing in a source document, to being detected or determined as being previously translated, to being checked by a translator, and to ultimately being stored within a translation memory program; and

FIG. 8 illustrates a technical flow chart representative of the inverse of the detailed sequential steps performed by the partial sentence translation memory algorithm to determine partial sentences, or phrases, that have been previously translated of FIG. 5.

### DETAILED DESCRIPTION OF THE PREFERRED EMBODIMENTS

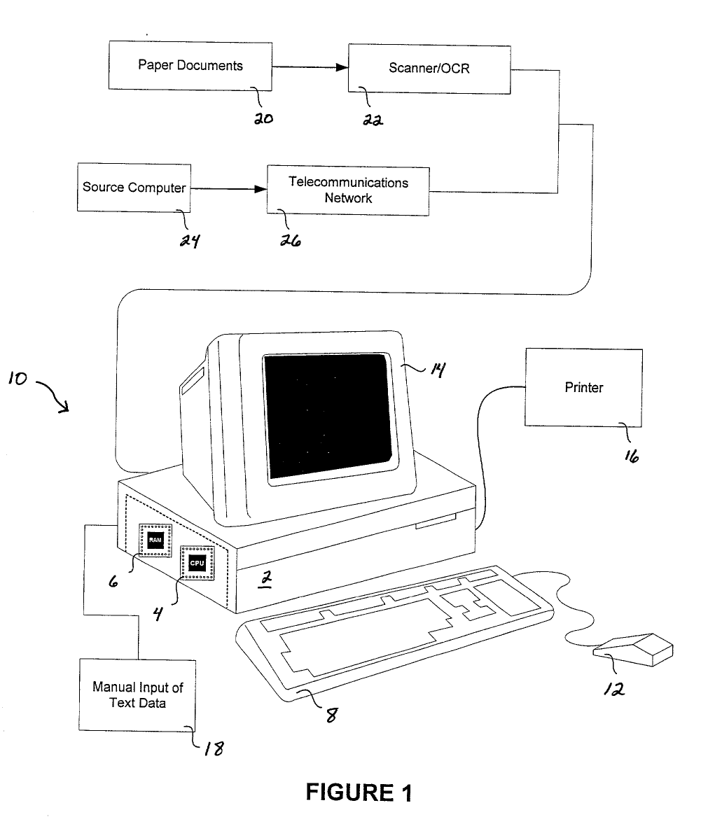

It will be readily understood that the components of the present invention, as generally described and illustrated in the figures herein, could be arranged and designed in a wide variety of different configurations. Thus, the following more detailed description of the preferred embodiments of the system and method of the present invention, as represented in FIGS. 1 through 7, is not intended to limit the scope of the invention as claimed, but is merely representative of the presently preferred embodiments of the invention.

The presently preferred embodiments of the invention will be best understood by reference to the drawings, wherein like parts are designated by like numerals throughout.

### I. General Discussion of Translation Memory Systems

Employing the use of computer systems to reduce the translation time and to aid in the translation of material is referred to in the industry as machine assisted human translation (“MAHT”) or interactive translation. Machine assisted human translation has focused on ways of using computer systems to significantly reduce the amount of autonomous time and effort required to complete a translation. Within the MAHT environment are several tools and/or aids that a translator may use to receive assistance in the translation of the source material. MAHT and Terminology Management Tools are based on the concept of automating the re-use of previously translated sentences. These tools are designed for use by professional translators and do not automatically produce computer-generated translations. Instead they allow the translator to improve his/her productivity and consistency by re-using terms and sentences they have translated in the past. Among these tools include electronic dictionaries or terminological databases. However, more sophisticated tools are available to the translator as a result of the technological advancements of the computer system.

An example of a more sophisticated MAHT tool is a translation memory (“TM”). A translation memory is a database that collects translations as they are performed along with the source language equivalents and then provides the translator with the ability, or allows the translator, to access previously translated material easily and efficiently. A TM system also contains a database of sentences and their translations that has been built up from previous translation projects. A TM system follows along as a source document is translated, and subsequently stores these translated sentences. When the translator comes across identical or similar material, the TM allows the translator to reuse the previously translated material. This allows a translator to search the existing database for the most accurate sentence match and then return that match to the workbench program where the translator can edit and modify the translation for accuracy. Once the sentence has been translated accurately, it can be stored, along with the source sentence, into the database for later retrieval. This process continues until reaching the end of the source document, wherein a number of sentence translations have been performed and stored in the translation memory database. Subsequently, the TM database can be accessed to assist new translations where the new translation includes identical or similar source language text as has been included in the translation memory. In this regard, the level of benefit received from a TM is directly proportional to the amount of repetition in the document to be translated. In addition, the capabilities of the TM to assist in translating is also directly proportional to the number of varying sentences within the database.

The procedure by which TM systems are capable of producing high-quality and accurate translations is found in their ability to identify portions of a source language, from a source document, that are to be translated into a target language; then to extrapolate fragments of known or previously translated material of the target language, usually contained within an index or database, based upon the identified source language information, to create the translated target language. The remaining material from the source language or document that was unobtainable by the computer system is then filled-in autonomously to complete the translation. As stated above, prior art TM systems operate to extrapolate on a sentence by sentence basis. This means that only entire sentences may be recognized by the computer system and translated into the target language. For example, a translator wishing to translate a document from English to French, may be assisted by causing the computer system to extrapolate all previously translated sentences from the source document that are found in the index or database of previously translated material and returning their French equivalents. Those sentences not found must then be translated autonomously. In any event, the translator is interactively working within the translation environment with the TM to create and finalize the translated document, thus providing an efficient translation method.

The advantage of a TM operating within a MAHT environment is that it can leverage existing TM technology to make the translator more efficient, without sacrificing the traditional accuracy provided by a human translator. It makes translations more efficient by ensuring that the translator never has to translate the same source text twice. In the past, these systems have been slow. This has largely been a direct function of the state of computer systems and their ability to process large amounts of data. However, with the ever increasing processing power of computer systems, this is, for the most part, no longer an issue. TM systems provide significant advantages over manual translation. Some of these benefits include: improved translation consistency across an entire document, improved translation accuracy, reduction in total translation time and costs, and reduction in the time to market of products.

Translation memories are most effective when they are able to locate “fuzzy matches” as well as identical matches. Fuzzy matches facilitate the retrieval of text that differs slightly in word order, morphology, case, or spelling. By returning approximate matches, considerable time is preserved even though these sentences must be autonomously checked for accuracy. A translator's job is much easier if a significant starting point is provided from which he/she can work. In addition, approximations are necessary due to the numerous varieties possible in natural language texts. Some examples of existing translation programs, more commonly referred to as workbench programs, using “fuzzy” matches include Workbench program™ for Windows by Trados™ and Deja Vu™, published by Atril.

Translation memory programs do not analyze syntax or grammar, thus they are more language independent than other translation techniques. In practice, however, it has been difficult to implement search software that is truly language independent. In particular, existing search engines are word based, which is to say that they rely on a particular word as the basic element in accomplishing the search. This is especially true of “fuzzy” search methods. In each language, words change in unique ways to account for changes in gender, plurality, tense, and the like. Hence, word-based systems cannot be truly language independent because the words themselves are inherently language oriented. It has been a continuing difficulty to develop fast, accurate fuzzy text search methods.

### II. Partial Sentence Translation Memory

The present invention features a translation system comprising: (a) a computerized workstation; (b) a workbench program executable on the computerized workstation, the workbench program comprising at least one workbench program database of previously translated material; (c) a writeable text data software application program also executable on the computerized workstation, the writeable text data application program containing text data to be translated; and (d) a partial sentence translation memory program operable with the workbench program and optionally including a partial sentence translation memory database of previously translated material, the partial sentence translation memory program comprising computer-readable code that allows a user to determine, at a single glance, whether partial sentences in the source language have been previously translated. This is done by comparing the partial sentences within the text segment to either a database of previously translated material, e.g., the workbench program database or the partial sentence translation memory database.

The present invention also features a method for determining whether partial sentences of source text data have been previously translated. The method comprises the steps of: (a) executing a workbench program, such as TRADOS™, on a computer system; (b) executing a writeable text data application program on the computer system, the writeable text data application program being capable of interfacing with the workbench program; (c) entering text data, written in a source language, into the writeable text data application program, wherein the text data comprises at least one text segment; (d) identifying the text segment to be operated upon; (e) accessing a partial sentence translation memory program from the computer system, the partial sentence translation memory interfacing with the workbench program and the writeable application program, the workbench program containing at least one database of previously translated material, with either the partial sentence translation memory or the workbench program being capable of determining whether the text data has been previously translated; (f) comparing the text segment with the previously translated material to determine those partial sentences within the text segment that have been previously translated; and (g) displaying the partial sentence translations on the computer within a graphical user interface environment. These translations could also be displayed in context as they existed in the database.

The step of comparing itself, as described above, is the crux of the invention and may comprise the steps of determining a first longest partial sentence translation in the text segment, wherein the first longest partial sentence translation ends with the last word in the text segment; determining a second longest partial sentence translation, the second partial sentence translation starting with the word directly preceding the first word of the first longest partial sentence translation, the second partial sentence translation defining the longest partial sentence translation beginning with the word; and repeating the step of comparing as often as necessary to obtain the longest partial sentence translation that starts with each word in the text segment.

The step of comparing may alternatively comprise, as an inverse to the above described step of comparing, the steps of determining a first longest partial sentence translation in said text segment, wherein said first longest partial sentence translation starts with the first word in said text segment; determining a second longest partial sentence translation, said second partial sentence translation ending with the word directly after the last word of said first longest partial sentence translation, said second partial sentence translation defining the longest partial sentence translation ending with said word; and repeating said step of comparing as often as necessary to obtain the longest partial sentence translation that ends with each word in said text segment.

Each of the above-described steps may be repeated as often as necessary for determining partial sentences from any identified text segment within the writeable text data application program. In addition, the method further comprises the step of storing the partial sentence translations for later use.

The purpose of the algorithm of the present invention is to allow a translator to see at a single glance what parts of a text segment within a source document have been previously translated. Specifically, a translator is able to find or determine previously translated sentence fragments, such as phrases or other non-sentence structures. As such, a phrase may be considered as simply a sequence of words contained within a segment of text.

Essentially, the algorithm causes a computer to access a database of previously translated material. This database can be based on either the workbench program's database, or on the partial sentence translation memory database, or any other suitable database. What is critical is that the present invention contains, or interfaces with a program that contains, computer readable code, or a software function, that directs a computer to determine whether or not a given phrase from a source document has been previously translated.

Upon the introduction of a source document within a translator workbench, and the determination of a target language, the algorithm begins by analyzing a word string or text segment, as identified by the translator, from the source document contained within a word processing program or other text data program. This text segment may be a sentence or partial sentence, such as a phrase. The algorithm operates upon the text segment by causing a software function to see if the last word contained within the text segment has been previously translated. If the last word has been translated before, the last two words of the text segment are considered a phrase. The software function is then used to determine if this phrase, comprising the last two words of the segment, has been previously translated. If it has, the last three words are considered as a phrase. The software function is then used to determine if this phrase, comprising the last three words of the segment, has been previously translated. If it has, the last four words are considered and defined as a phrase. This process, or these iterations, continue until a phrase is found as not having been previously translated, or in other words, the software cannot define the next sequential phrase as having been previously translated. The program then commences to mark the previous phrase that was determined as having been previously translated, identifying it as the longest phrase from the end of the text segment that has been previously translated. The software program determines these phrases by checking them with the translation memory as described herein.

The next step performed by the algorithm of the present invention is to determine the longest phrase in the same text segment that starts or begins with the word just before the beginning word in the phrase just marked as the longest phrase from the end of the text segment. Rather than trying all of the phrases that start with this word, a phrase that stretches only halfway to the end of the segment is tested with the software function. If it has been previously translated, a phrase that stretches three-fourths of the way to the end of the segment is tested. If the software function determines that the phrase that stretches only halfway to the end of the segment has not been previously translated, a phrase that only stretches one-fourth of the way to the end of the segment is tested. After each test, a phrase is tested whose last word is halfway between the last successful test and the last failed test until the longest phrase starting with that word is found and marked.

Each time a longest phrase is found and marked, the same phrase is tested which ends with the same ending word, but begins with the word before the starting word. If it is found, it must be the longest translated phrase that begins with the new starting word, so it is marked. If it is not found, the procedure described in the previous paragraph is used to determine the longest translated phrase that begins with the new starting word.

This backward proceeding procedure is repeated over and over again until the longest phrase, determined as being previously translated, that starts with each word in the text segment has been determined. By the nature and logistics of the algorithm, any partial sentence that consists of a single word is removed from the list, and any phrase that is completely contained by another phrase in the list is also removed.

Again these steps are achieved by checking the phrases with the translation memory, wherein the translation memory is created and/or updated as described herein. Moreover, again, the algorithm as presented and described herein may be designed to perform the inverse of these steps.

FIG. 1 illustrates a computer system environment wherein a user may input text data into the computer system either manually, or by voice, or by scanning, or through some other source such as importing via telecommunications networks. This text data represents the text data of the source language that is to be translated into a target language.

Specifically, FIG. 1 shows a translation system 10, or translator's workbench, as contained and operable on computer system 2. Computer system 2 comprises central processing unit 4, random access memory 6, keyboard 8, mouse 12, monitor 14, and printer 16. Other computer components not shown may also be included as this illustration is only intended to be an example. FIG. 1 illustrates how text data is input or entered into computer 2. Text data may be manually entered as represented by box 18. The most common way to manually enter text data is by typing on a keyboard using a word processor or other application program. Text data may also be entered into computer system 2 by scanning paper documents 20 into scanner 22, or by obtaining or importing text data from a another computer 24, such as via a telecommunications network 26. FIG. 1 is not meant to be limiting in any way. One ordinarily skilled in the art will recognize the many possible ways in which text data may be entered and stored on a computer system, to be further processed and worked upon.

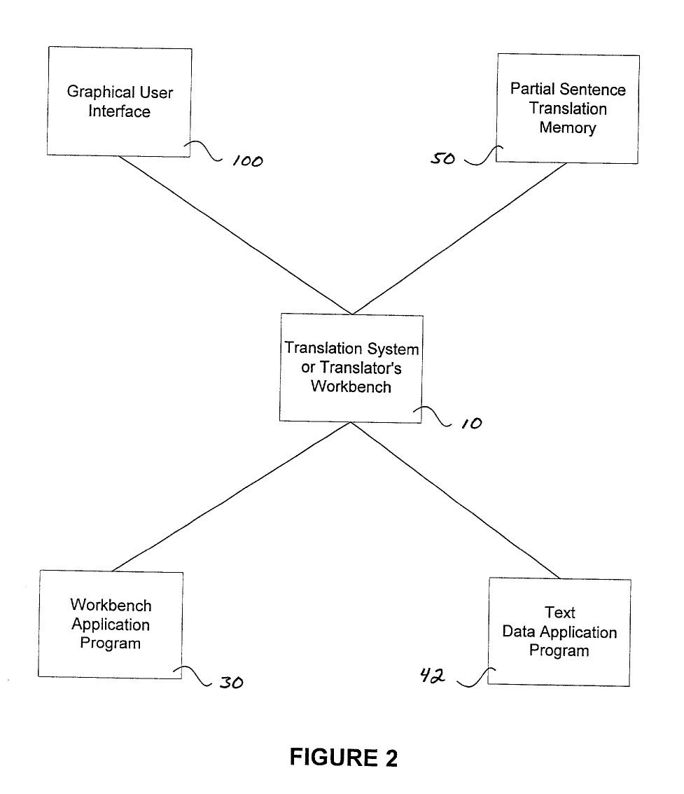

FIG. 2 is illustrative of translation system 10. Shown are the many elements and components needed to carry out the present invention along with their interaction with each other. Translation system 10 utilizes an existing workbench program 30, such as TRADOS , etc., to create and access a database that collects and stores previously translated material, and that is capable of determining whether text data has been previously translated. Workbench program 30 also contains a database of sentences and their translations that has been built up from previous translation projects that is accessible via workbench program 30. The workbench program allows the translator to access the database of previously translated material easily and efficiently. When the translator comes across identical or similar material, the workbench program allows the translator to reuse the previously translated material.

FIG. 2 also shows text data application program 42. Text data application program 42 serves as the vehicle for providing text data that is to be operated upon within the translator's workbench. Suitable text data application programs may include word processor software programs such as Microsoft Word™, Corel WordPerfect™, or others. As text is input or entered into text data application program 42, it may then be further processed. In essence, the text may be operated on by the computer system and translation system to see if source text data has a corresponding target translation. Portions or segments of the target language may then be stored in one of several data bases which will be discussed further below.

Once the text data is entered, translation system 10 calls upon a partial sentence extraction subroutine/algorithm, or partial sentence translation memory, 50 and workbench program 30 to determine, at a single glance, what partial sentences existing within the selected text data have been previously translated. The user is capable of monitoring and working within the translation system 10 via graphical user interface 100. Graphical user interface 100 may be any interface known in the art.

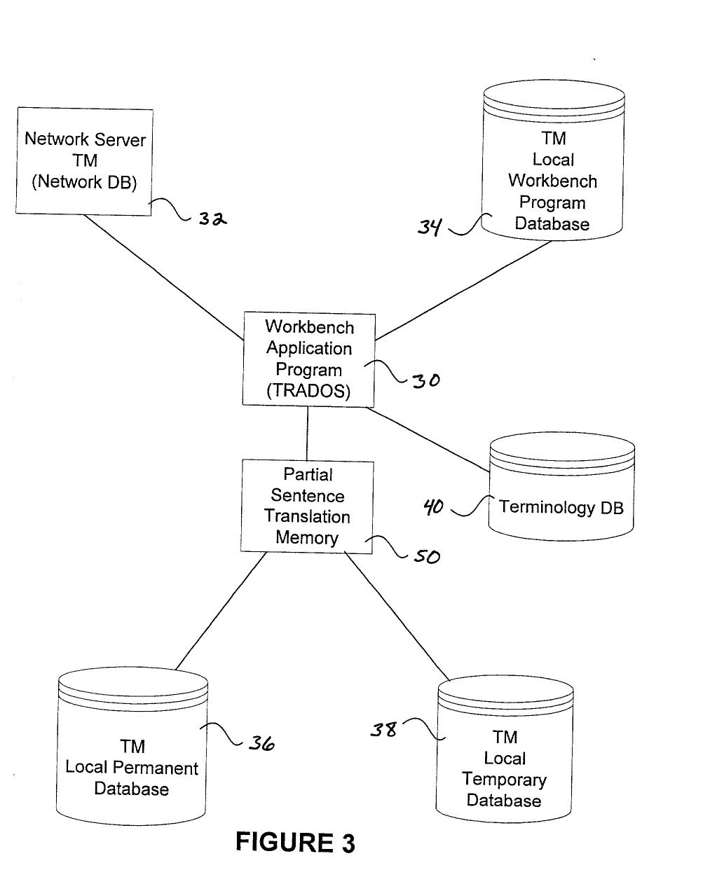

FIG. 3 is illustrative of the interrelation between workbench program 30 and partial sentence translation memory 50, and the various translation memory databases interacting with these two. Specifically, what is shown is the ability for workbench program 30 to access a network server translation memory database (“network TM database”) 32, which is capable of providing information to several interconnected translator workbenches or workstations, or a local workbench program translation memory database 34, or both if desired by the user and set up properly. This is not new in the art and is only meant for illustration purposes only. One ordinarily skilled in the art will recognize how partial sentence translation memory program 50 may operate within various translation memory programs, TRADOS being only one of such programs.

Partial sentence translation memory 50 runs in conjunction with workbench program 30 to carry out the translation procedures as described herein. Each workstation, only one of which is shown here, may contain a local workbench program translation memory database 34, a local permanent translation memory database (“permanent TM database”) 36, a local temporary translation memory database (“temporary TM database”) 38, and a terminology database 40. These databases contain material or information that has been previously translated and that may be accessed to assist the translator in various translations. Permanent TM database 36, and temporary TM database 38 are keyed off of and are utilized by partial sentence translation memory 50, while local workbench program translation memory database 34 and network server translation memory database 32 are keyed off of and utilized only by workbench program 30.

When translating, a user executes workbench program 30 from a computer workstation. Workbench program 30 can be any known translation memory program, such as TRADOS® or MTX, and is designed to operate on, or work with, text data present in a word processing program, such as Microsoft Word® or Corel WordPerfect®, or any other application program containing text data. Included in either the workbench program or the partial sentence translation memory program is a software function that can determine whether or not a given partial sentence has been previously translated. Preferably, punctuation and grammar are ignored, so a partial sentence, or phrase, is considered to be simply a sequence of words. Each of the above-described databases are made operational through either workbench program 30, or partial sentence translation memory 50, respectively. Workbench program 30 includes workbench translation memory database 34, which contains the necessary tools and operational commands necessary to determine whether any selected text data has been previously translated from a source language to a target language. As partial sentence translation memory 50 is executed, it works in conjunction with workbench program 30 to determine whether a partial sentence has been translated. In this preferred embodiment, partial sentence translation memory 50 utilizes workbench program 30 to obtain or access previously translated material. As stated, partial sentence translation memory 50 may itself contain the ability to access previously translated material. Partial sentence translation memory 50 operates to substantially reduce the number and degree of “fuzzy” matches often returned by workbench program 30.

To provide a detailed description of the databases, temporary TM database 38 is an optional or discretionary database that is operational during a current text data translation session. Temporary TM database 38 contains and stores the words, phrases, and sentences that have been translated during that session. In essence, temporary TM database 38 stores sentences and phrases, and their translations, for use in the current translation session. These are translations that the user or translator translates and enters autonomously. When the current work session is started, and Workbench program 30 and partial sentence translation memory 50 are executed, temporary TM database 38 receives from and stores new text data that is translated during the current translation session.

Although not a critical aspect of the present invention, as the translation session progresses and text data in a source language is operated upon to see if any given partial sentences or phrases contained within the text data have been previously translated, the user may wish to store the translated text. To do so, the user downloads the information currently stored in temporary TM database 38 to permanent TM database 36, which is a database that receives and stores previously translated material for later use. This is preferably an inverted word index. Permanent TM database 36 is also accessible during the translation session to provide the user with previously translated material which can be used to translate new text data.

If several workstations are interconnected within a network, network TM database 32 may be used to receive and store previously translated material stored on the permanent TM databases of any or all of those workstations. Upon translating text data, the user may upload this information to network TM database where it may be accessible by any number of users, so that each may share the information uploaded from the other workstations.

FIG. 3 also shows terminology database 40, which comprises a dictionary of translated words and/or phrases that are entered into the database manually once the correct translation is determined by the translator. Once the data is entered, it may later be accessed to assist in the translation process.

The specifics of using a translation memory software program within a translation workstation are well known in the art and are not described herein. Only a brief description of these systems has been provided as this is not the focus of the present invention. One ordinarily skilled in the art will understand the workings these systems together with a text data application program. These systems are merely provided as background information and are intended to be used with the partial sentence translation memory technology described below.

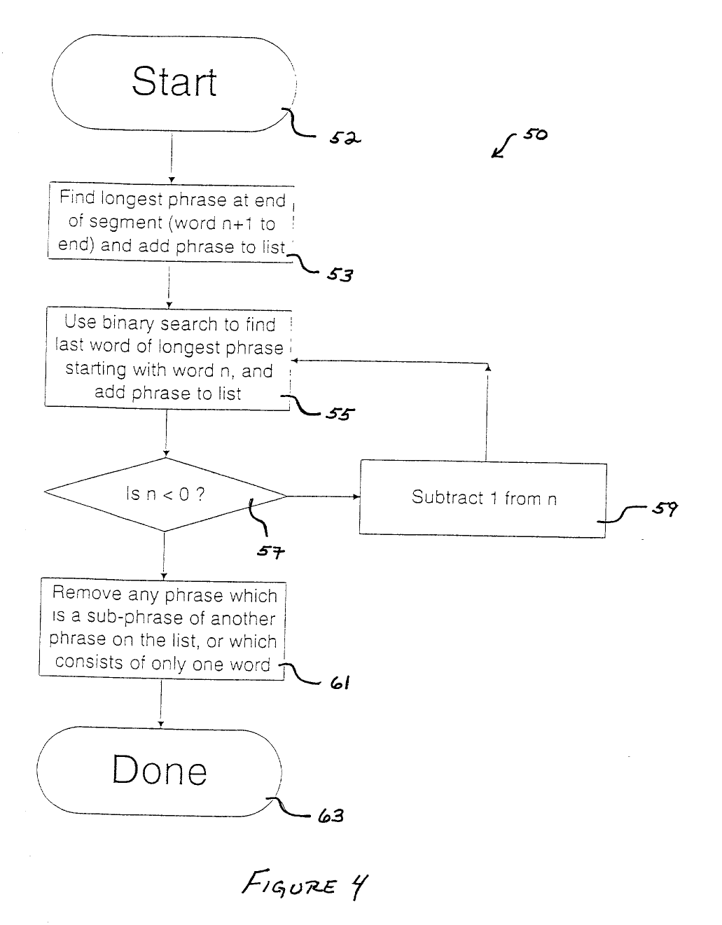

FIG. 4 illustrates, generally, the method for identifying partial sentences, within a source language text segment, that have been previously translated, as dictated by the partial sentence translation memory program or algorithm of the present invention. It should be noted that the present invention, and specifically the partial sentence translation memory algorithm, is designed to work with known workbench programs and already existing stored databases, as well as being capable of creating and accessing its own database of previously translated partial sentences or phrases, such as in an inverted word index.

Partial sentence translation memory 50 comprises starting point 52, which leads into first finding the longest phrase at the end of a text data segment, shown as 53. A text data segment can be a sentence, a subset of a sentence, or two or more straddled sentences, such as text at the end of one sentence and text at the start of the next sentence. Basically, a text data segment is any segment of words grouped together. The longest phrase is found by starting with the last word in the text data segment and checking that with a translation memory database to see if that word has been translated before. If it has, that word plus the second to last word are considered a phrase and also checked. If that phrase has been previously translated, the next word and resulting phrase proceeding backwards through the text data segment is checked. Essentially, the algorithm moves backwards through the text data segment, n being the next word beyond the phrase that has been checked and found to have been previously translated. Once the system finds a phrase that has not been translated, the phrase checked just prior to the untranslated phrase is marked as the longest phrase of the sentence found to be previously translated. In this step, the longest phrase from the end of the text data segment that is determined to have been previously translated is marked.

The algorithm then proceeds by using a binary search to determine the longest phrase starting with the word before the beginning of the phrase just marked, starting with the word n, shown in FIG. 4 as 55. Once found this phrase is added to the list of previously translated phrases. This step is repeated several times, using n−1 shown generally as 59, until the longest phrase that starts with each word in the segment has been determined, i.e., until n<0, shown as 57. Moreover, the algorithm eliminates any partial sentence, or phrase, that consists of a single word, or any partial sentence, or phrase, that is completely contained by another phrase, shown as 61. At this stage, the partial sentence translation is complete, shown as 63, and can be used again for any number of text data segments.

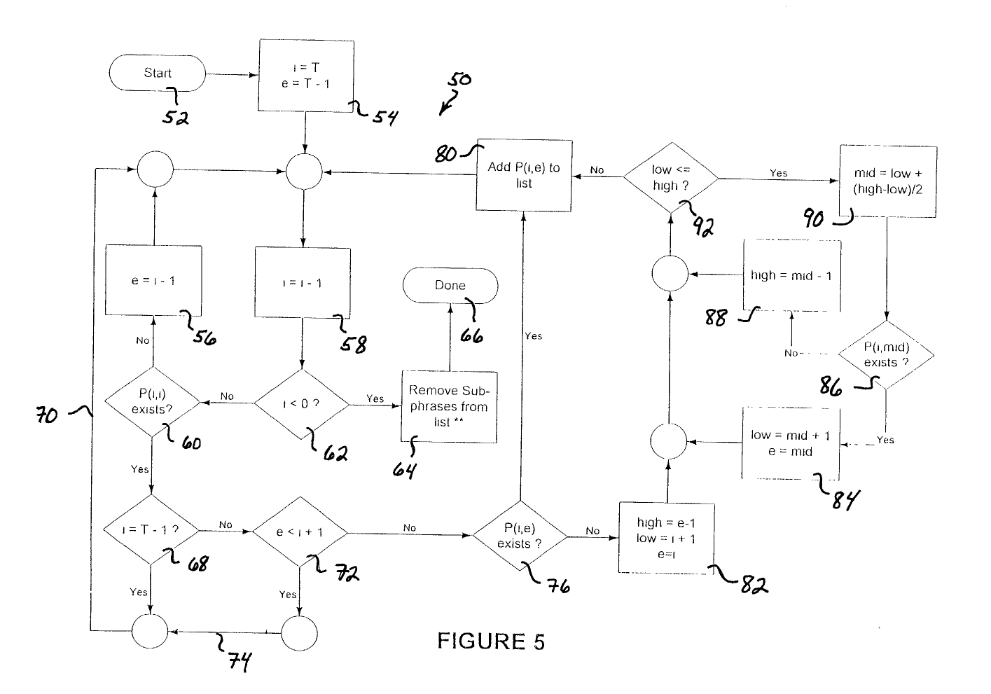

FIG. 5 illustrates a technical flow chart representative of the detailed sequential steps performed by the partial sentence translation memory algorithm as just generally described. As defined, “T” is the total number of words in the segment (the segment contains words 0 through T−1), “P(n,m)” is the phrase from word n to word m, “i” is a counter, used to move backward through the sentence, “e” is a placeholder pointing to the last word of the phrase currently being investigated, and the number “0” is the first word of the text data segment. Each box is designated by a numeral followed by a description of that step in the translation algorithm.

Start 52 of the algorithm of the present invention comprises highlighting or identifying a text data segment existing in the word processor. The text data segment may be obtained using any known means in the art, such as typing, scanning, importing, etc. At this stage, the user initiates the Workbench program and partial sentence translation memory algorithm to begin identifying previously translated partial sentences, or phrases, within the text data. The translation system of the present invention is capable of operating on the text data segment within the translation workbench to identify previously translated partial sentences, or phrases, from that text data segment using the partial sentence translation memory algorithm described in detail in FIG. 5 below. Referring now to FIG. 5:

“i=T.” “e=T−1” 54. This points e to the last word of the segment, and i past the end of the segment so it will be the last word in the segment in the next step.

“i=i−1” 58 decrements i to the previous word in the sentence. On the first time through, it points i to the last word of the sentence.

“i<0?” 62. If i is less than 0, i has gone backward through the whole segment, so all phrases in the segment which are also in memory have already been added to the list.

“Remove sub phrases from list” 64. The algorithm compiles of list of phrases that are found in translation memory. It is possible that both P(n,m) and P(n+1,m) are in the list. Only the longest phrases found in memory will be displayed to the user, so P(n+1,m) is removed from the list in each such case. Phrases of length 1, which are phrases comprising only a single word, from the binary search below are also removed at this point, thus removing all phrases in the list that are sub-phrases of other phrases in the list.

“Done” 66. At the end of the algorithm, the list contains the longest phrases in the current segment, which are found in translation memory.

“P(i,i) exists?” 60. This is true if word i exists anywhere in translation memory.

“e=i−1” 56. Since word i is not known anywhere in translation memory (the last step), word i cannot be part of a phrase found in translation memory. The word before i, namely i−1, is the last word that could possibly be the end of a translation memory phrase, for any words earlier in the segment.

“i=T−1?” 68. If i is T−1, there is no need to consider the phrase P(i,i) for the list, because it is only one word. Only phrases of 2 or more words will be added to the list at this point.

“e<i+1” 72. In this case, the phrase P(i,e) would be less than 2 words long, so it does not need to be considered. Only phrases of two or more words will be added to the list at this point.

“P(i,e) exists?” 76. This is true if the phrase from word i to word e is found in translation memory.

“Add P(i,e) to list” 80. This is the list of phrases from the segment that occur in translation memory. The value of e either comes from e=i when P(i,i) exists (which is removed later), or from e=mid when P(i,mid) exists in steps 84 and 86.

“high =e−1,” “low =i+1,” “e=i” 82. This starts a section of the algorithm which is basically a binary search like the binary search algorithm in the work by Kernighan and Ritchie, which is incorporated by reference herein. All of the steps below are also part of the binary search. Since P(i,e) didn't exist in the last step, i.e. the phrase from word i to word e was not in translation memory, this section does a binary search for the last word of a phrase starting with word i that is in translation memory. If a phrase beginning with word i is in translation memory, the last word that could possibly end such a phrase is e−1, since P(i,e) is not in translation memory, so we let high=e−1, the last possible word. The first word that could possibly end a two or more word phrase starting with word i is word i+1 (low=i+1). The guess is halfway between low and high (mid), to see if that phrase is in translation memory. If it is, the next guess is halfway between mid and high, and so forth; if it isn't, the next guess is halfway between low and mid, and so forth.

“low<=high?” 92. If this is true, there may be a longer phrase that could be added to the list, so the binary search is continued.

“mid=low+(high-low)/2” 90. Word mid is the word halfway between an end word that succeeds (P(i,low−1) exists), and an end word that does not succeed (P(i,high+1) does not exist).

“P(i,mid) exists?” 86. The halfway guess is checked to see if the phrase is in translation memory.

“high=mid−1?” 88. Since the phrase from word i to word mid was not in translation memory, the last word that could possibly end a phrase starting with i is word mid−1, the new high.

“low=mid+1,” “e=mid” 84. Since the phrase from word i to word mid was found in translation memory, the next phrase to try must end no earlier than mid+1. P(i,mid) could be added to the list if no longer phrases are found starting with word i, so the algorithm sets e=mid so that P(i,e) can be added to the list later.

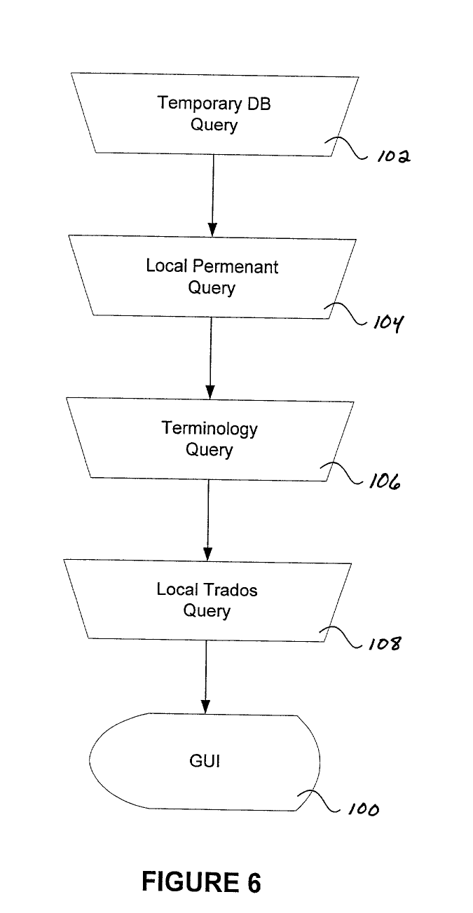

FIG. 6 illustrates the graphical user interface and the several databases that may be retrieved and viewed therein. These are only illustrative, and are not intended to be limiting in any way. Temporary database 102 is a local database existing on the workstation computer during a translation session and is displayed on the GUI 100. As the user identifies previously translated text data from its source language to a target language, temporary database 102 stores and shows the user what is currently being translated. This information may then later be stored in a permanent database 104 if desired. Permanent database 104 may be stored on a hard drive or on a network drive. Permanent database 104 may also be queried so that the user may retrieve information from that database at any time during the translation session. For example, if a text data segment is being transferred, permanent database 104 may be accessed and shown on GUI 100 at any time.

Also displayable at any time on GUI 100 is terminology database 106 and the local translation software program database 108, shown as a TRADOS® database. These databases function as described above and are included in the discussion of FIG. 6 to show their interaction with GUI 100.

As an embodiment, the present invention may also comprise a partial sentence or phrase match window. This window would allow the translator to see each previously translated source language partial sentence in the context in which it existed in the database in which it was found.

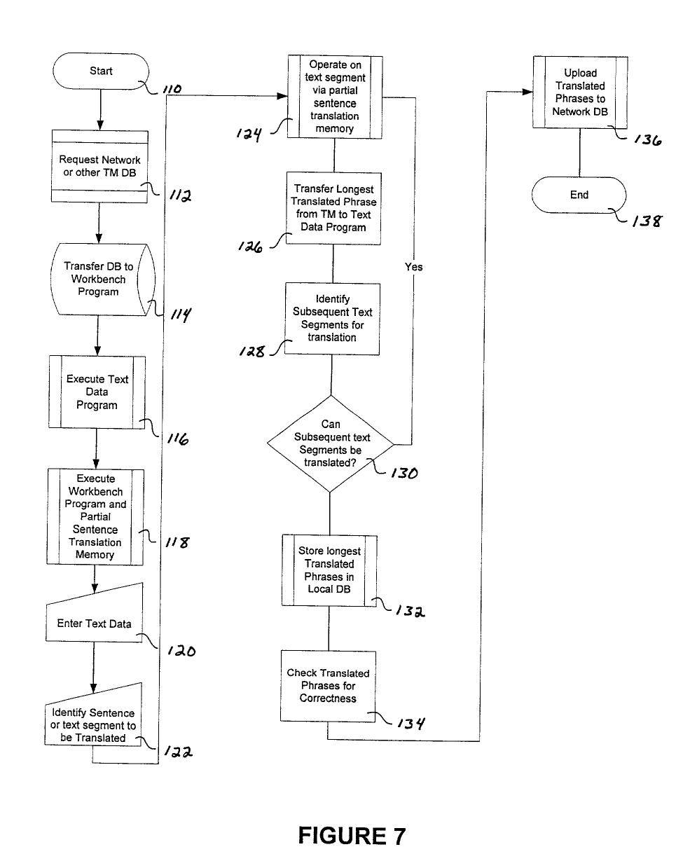

FIG. 7 illustrates a flowchart showing the life cycle of an identified previously translated partial sentence as it progresses from existing in a source document, to being identified as being previously translated, to ultimately being stored within the translation memory program. Each number in the figure represents a step in the process.

First, a user may request a network or other translation memory database 112 and transfer this database to the workbench program 114 executed on the workstation. Within the workstation, a writeable text data application program is executed 116. From the writeable text data application program, the partial sentence translation memory, containing the algorithm as described herein, and the workbench program may be executed 118. This is preferably done using a series of macros to call the necessary functions, but may also be done using any known means in the art. In the writeable text data application program, text data may be entered 120, wherein the text data is in a source language. From this source language, partial sentences may be identified and returned in a target language as a result of the partial sentence translation memory program or algorithm.

Once the text data is entered, a portion of the text data may be selected. This selected portion identifies and defines the text segment to be translated 122. Once identified, the text segment may be operated upon by execution of the partial sentence translation memory of the present invention 124. The partial sentence translation memory of the present invention identifies or determines, within the text segment, any partial sentences that have been previously translated by comparing the text segment to a database containing previously translated material. The partial sentence translation memory seeks out the longest partial sentences within the identified text segment that have been previously translated and returns these results to the translator or user. Once identified, these partial sentences and their translations in context are displayed to the translator, who can then transfer them, such as by copy and paste, into the text data application program 126. Other text segments in the text data may be operated upon 128 using the same method and technique 130 until there are no longer any text segments left to translate in the source document.

Upon translating one or more of the text segments in the text data, these returned sentences in the target language may then be stored in a database 132 for later use. The database is typically a permanent database located on the user's hard drive. However, the database could also be stored on a network. Once stored, these translated sentences may be checked by the individual for correctness and accuracy 134. If found satisfactory, these translated partial sentences can be uploaded to a network 136 where any number of individuals may access the translated material to assist them in subsequent translations of source works.

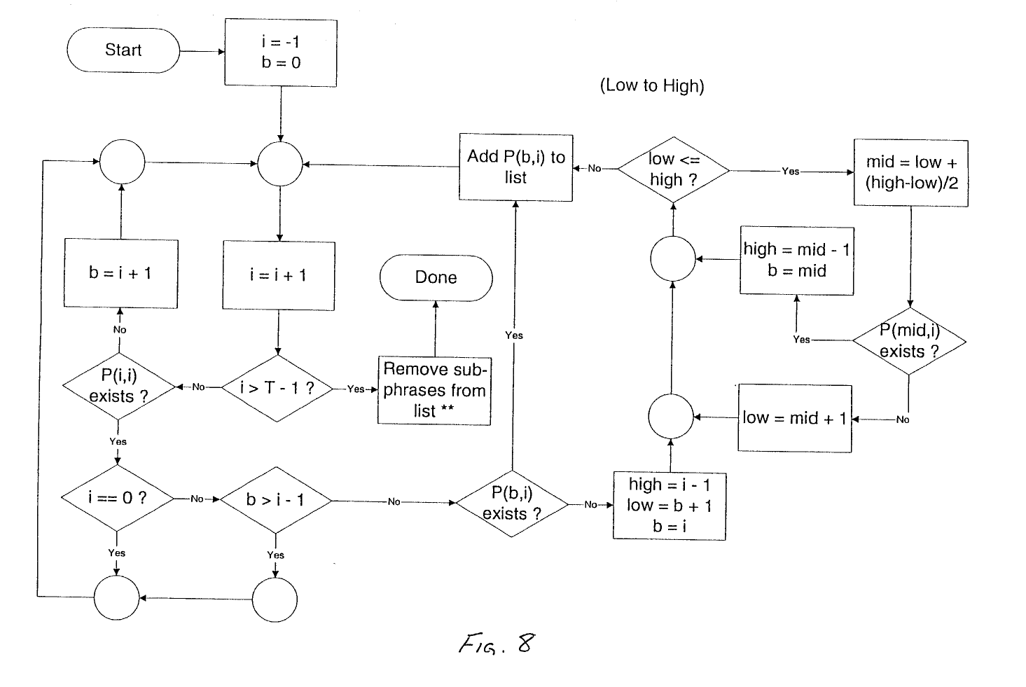

FIG. 8 is illustrative of the inverse of the detailed technical flow chart representative of the detailed sequential steps performed by the partial sentence translation memory algorithm as described in FIG. 5. In short, the partial sentence translation memory program may be designed to operate in an inverse manner as taught and described in FIG. 5 by beginning with the first word of the text segment and proceeding in subsequent iterations with the second word, the third word, and so on.

The present invention further features a computer readable medium containing instructions to direct a computer: (a) to interface with a pre-existing workbench application program stored and executable on a computer system, the workbench application program comprising at least one database of previously translated material; and (b) to operate on a text segment existing within a writeable text data application program, for the purpose of identifying or determining, within the text segment, any previously translated partial sentences, by identifying and translating the text segment based upon a partial sentence basis as compared with the database of previously translated material. The identification of previously translated partial sentences existing within the text segment comprises a first longest partial sentence, which ends with the last word in the text segment that has been previously translated, a second longest partial sentence in the text segment and begins with the word just preceding the first word in the first longest partial sentence, and a plurality of partial sentences, each beginning with a different word in the text segment. As stated above, the inverse of these may be achieved to accomplish the same results.

The present invention further features a program storage device readable by a computer tangibly embodying a program of instructions executable by the computer to perform method steps for determining partial sentences, existing within a text segment, that have been previously translated, the method comprising the steps of: (a) generating text data within a writeable application program, the text data comprising a plurality of text segments; (b) identifying at least one of the text segments; (c) executing a partial sentence translation memory on the computer system, the partial sentence translation memory optionally including a database of previously translated material; (d) interfacing the partial sentence translation memory with a workbench program comprising at least one database of previously translated material; and (e) operating on the at least one identified text segment, for the purpose identifying or determining any partial sentences contained in the text segment that have been previously translated, the operation completed either by (i) comparing the last word in the text segment with the workbench program to determine whether the last word has been previously translated, wherein if the last word has been previously translated then the last two words in the text segment are considered a partial sentence and the last two words are compared with the translation memory to determine whether they have been previously translated, wherein if the last two words have been previously translated then the last three words in the text segment are considered a partial sentence and the last three words are compared with the translation memory, wherein this process step continues until the longest previously translated partial sentence is determined, wherein the longest partial sentence is marked as having been previously translated; (ii) determining the longest partial sentence beginning with the word just prior to the beginning of the marked partial sentence by comparing the partial sentence with the translation memory; (iii) repeating the process of the previous step until the longest partial sentence, using each word in the text segment as a starting point, respectively, is determined; and (iv) returning the results to a graphical user interface; or (i) comparing the first word in the said text segment with one of said databases of previously translated material to determine whether said first word has been previously translated, wherein if said first word has been previously translated then the first two words in said text segment are considered a partial sentence and said first two words are compared with said translation memory to determine whether they have been previously translated, wherein if said first two words have been previously translated then the first three words in said text segment are considered a partial sentence and said first three words are compared with said translation memory, wherein this process step continues until the longest previously translated partial sentence is determined, wherein said longest partial sentence is marked as having been previously translated; (ii) determining the longest partial sentence ending with the word just after the end of said marked partial sentence by comparing said partial sentence with said translation memory; (iii) repeating the process of the previous step until the longest partial sentence, using each word in the said text segment as an ending point, respectively, is determined; and (iv) returning said results to a graphical user interface.

The above recited method may further comprise the step of storing the translations for later use.

The present invention finally features a computer readable memory medium including code for directing a computer to determine partial sentence translations, the computer readable memory medium comprising: (a) means for controlling the computer to receive and process text data in a writeable application program, the text data intended for translation; (b) means for controlling the computer to identify at least a portion of the text data to define a text segment; (c) means for controlling the computer to execute a partial sentence translation memory; (d) means for controlling the computer to interface the partial sentence translation memory with a workbench program comprising at least one database of previously translated material; and (e) means for controlling the computer to identify within the text segment any partial sentences that have been previously translated, the partial sentences determined by identifying a plurality of longest previously translated partial sentences as compared with the database of previously translated material.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A translation system comprising:
a computerized workstation;
a workbench program executable on said computerized workstation;
a writeable text data software application program executable on said computerized workstation, said writeable text data application program containing text data to be translated; and
a partial sentence translation memory operable with said workbench program and said writeable text data software application program, said partial sentence translation memory comprised of computer-readable code that allows a user to determine, at a single glance, whether partial sentences within said text data have been previously translated by comparing said partial sentences with a database of previously translated material.

2. The translation system of claim 1, wherein said database of previously translated material is contained within said partial sentence translation memory.

3. The translation system of claim 2, wherein said partial sentence translation memory utilizes said database contained therein to determine whether said partial sentences have been previously translated.

4. The translation system of claim 1, wherein said database of previously translated material is contained within said workbench program, said partial sentence translation memory utilizes said database contained within said workbench program to determine whether said partial sentences have been previously translated.

5. The translation system of claim 1, wherein said partial sentence translation memory allows said user to identify a text segment of said text data of said source language and to determine which partial sentences within said text segment have been previously translated by comparing said partial sentences with said database.

6. The translation system of claim 1, wherein said partial sentence translation memory ignores punctuation and capitalization.

7. The translation system of claim 1, wherein said text data is selected from a group consisting of words, phrases, characters, and symbols.

8. The translation system of claim 1, wherein said writeable text data software application program is selected from the group consisting of a word processor program, a spread sheet program, a presentations program, and any text program recognized by a computer.

9. The translation system of claim 1, wherein said text data is entered into said text data program using methods selected from the group consisting of typing, scanning, importing, FTP, and importing from a network program.

10. A method for determining whether partial sentences of source text data have been previously translated, said method comprising the steps of:
executing a workbench program on a computer system;
executing a writeable text data application program on said computer system, said writeable text data application program capable of interfacing with said workbench program;
entering text data, written in a source language, into said writeable text data application program, said text data comprising at least one text segment;
identifying said text segment to be operated upon;
accessing a partial sentence translation memory from said computer, said partial sentence translation memory interfacing with said workbench program and said writeable application program;
comparing said text segment with a database containing previously translated material to determine those partial sentences within said text segment that have been previously translated; and
displaying said partial sentence translations on said computer.

11. The method of claim 10, wherein said database of previously translated material is contained within said workbench program.

12. The method of claim 10, wherein said database of previously translated material is contained within said partial sentence translation memory.

13. The method of claim 10, wherein said step of comparing comprises the steps of:
a) determining a first longest partial sentence translation in said text segment, wherein said first longest partial sentence translation ends with the last word in said text segment;
b) determining a second longest partial sentence translation, said second partial sentence translation starting with the word directly preceding the first word of said first longest partial sentence translation, said second partial sentence translation defining the longest partial sentence translation beginning with said word; and
c) repeating said step of comparing as often as necessary to obtain the longest partial sentence translation that starts with each word in said text segment.

14. The method of claim 10, wherein said step of comparing comprises the steps of:
a) determining a first longest partial sentence translation in said text segment, wherein said first longest partial sentence translation starts with the first word in said text segment;
b) determining a second longest partial sentence translation, said second partial sentence translation ending with the word directly after the last word of said first longest partial sentence translation, said second partial sentence translation defining the longest partial sentence translation ending with said word; and
c) repeating said step of comparing as often as necessary to obtain the longest partial sentence translation that ends with each word in said text segment.

15. The method as recited in either claim 13 or claim 14, wherein said steps are repeated as often as necessary for determining partial sentences from any number of identified text segment within said writeable text data application program.

16. The method of claim 10, further comprising the step of storing said partial sentence translations in a database for later use.

17. The method of claim 10, wherein said database is stored in a permanent database on said computer system.

18. The method of claim 10, wherein said database is stored on a network.

19. A computer readable medium containing instructions to direct a computer:
to interface with a pre-existing workbench application program stored and executable on a computer system, said workbench application program comprising at least one database of previously translated material; and
to operate on a text segment existing within a writeable text data application program, for the purpose of identifying, within said text segment, any previously translated partial sentences as determined by comparing, on a partial sentence basis, said text segment with said database of previously translated material.

20. The computer readable medium of claim 19, wherein said partial sentence comprises a first longest partial sentence, which ends with the last word in said text segment that has been previously translated.

21. The computer readable medium of claim 20, wherein said partial sentence is a second longest partial sentence in said text segment and begins with the word just preceding the first word in said first longest partial sentence.

22. The computer readable medium of claim 19, wherein said partial sentence comprises a plurality of partial sentences, each beginning with a different word in said text segment.

23. A program storage device readable by a computer tangibly embodying a program of instructions executable by said computer to perform method steps for identifying partial sentences, existing within a text segment, that have been previously translated, said method comprising the steps of:
generating text data within a writeable application program, said text data comprising a plurality of text segments;
identifying at least one of said text segments;
executing a partial sentence translation memory on said computer system;
interfacing said partial sentence translation memory with a workbench program; and
operating on said at least one identified text segment, for the purpose of identifying any partial sentences contained in said text segment that have been previously translated, said operation completed by:
comparing the last word in said text segment with a database of previously translated material to determine whether said last word has been previously translated, wherein if said last word has been previously translated then the last two words in said text segment are considered a partial sentence and said last two words are compared with said database to determine whether they have been previously translated, wherein if said last two words have been previously translated then the last three words in said text segment are considered a partial sentence and said last three words are compared with said database, wherein this process step continues until the longest previously translated partial sentence is determined, wherein said longest partial sentence is marked as having been previously translated;
determining the longest partial sentence beginning with the word just prior to the beginning of said marked partial sentence by comparing said partial sentence with said database;
repeating the process of the previous step until the longest partial sentence, using each word in said text segment as a starting point, respectively, is determined; and
returning said results to a graphical user interface.

24. The method of claim 23, further comprising storing said partial sentence translations in said at least one database for later use.

25. The method of claim 23, wherein said database of previously translated material is contained within said workbench program.

26. The method of claim 23, wherein said database of previously translated material is contained within said partial sentence translation memory.

27. A program storage device readable by a computer tangibly embodying a program of instructions executable by said computer to perform method steps for identifying partial sentences, existing within a text segment, that have been previously translated, said method comprising the steps of:
generating text data within a writeable application program, said text data comprising a plurality of text segments;
identifying at least one of said text segments;
executing a partial sentence translation memory on said computer system;
interfacing said partial sentence translation memory with a workbench program; and
operating on said at least one identified text segment, for the purpose of identifying any partial sentences contained in said text segment that have been previously translated, said operation completed by:
comparing the first word in the said text segment with a database of previously translated material to determine whether said first word has been previously translated, wherein if said first word has been previously translated then the first two words in said text segment are considered a partial sentence and said first two words are compared with said database to determine whether they have been previously translated, wherein if said first two words have been previously translated then the first three words in said text segment are considered a partial sentence and said first three words are compared with said database, wherein this process step continues until the longest previously translated partial sentence is determined, wherein said longest partial sentence is marked as having been previously translated;
determining the longest partial sentence ending with the word just after the end of said marked partial sentence by comparing said partial sentence with said database;
repeating the process of the previous step until the longest partial sentence, using each word in the said text segment as an ending point, respectively, is determined; and
returning said results to a graphical user interface.

28. The method of claim 27, further comprising storing said partial sentence translations in said at least one database for later use.

29. The method of claim 27, wherein said database of previously translated material is contained within said workbench program.

30. The method of claim 27, wherein said database of previously translated material is contained within said partial sentence translation memory.

31. A computer readable memory medium including code for directing a computer to identify partial sentence translations, said computer readable memory medium comprising:
means for controlling said computer to receive and process text data in a writeable application program, said text data intended for translation;
means for controlling said computer to identify at least a portion of said text data to define a text segment;
means for controlling said computer to execute a partial sentence translation memory, optionally including at least one database of previously translated material;
means for controlling said computer to interface the said partial sentence translation memory with a workbench program comprising at least one database of previously translated material; and means for controlling said computer to identify, within said text segment, any partial sentences that have been previously translated, said partial sentences identified by determining a plurality of longest previously translated partial sentences as compared with one of said databases of previously translated material.
